(19) United States
(12) Patent Application Publication
(10) Pub. No.: US 2025/0308396 A1
(43) Pub. Date: Oct. 2, 2025

(54) AIRCRAFT COLLISION RISK DETERMINATION

(71) Applicant: ROCKWELL COLLINS FRANCE S.A.S., Blagnac (FR)

(72) Inventors: Philippe Salmon, Colomiers (FR); Lynn Daher, Toulouse (FR); Elias Bitar, Tournefeuille (FR)

(21) Appl. No.: 19/039,573

(22) Filed: Jan. 28, 2025

(30) Foreign Application Priority Data
Mar. 28, 2024 (EP) 24305482.2

(51) Int. Cl. G08G 5/80

(52) U.S. Cl. CPC G08G 5/80

(57) ABSTRACT

A method of determining an aircraft's risk of collision at a candidate position includes determining the candidate position which the aircraft is capable of traversing to within a time period, based on the aircraft's: i) initial position; ii) initial trajectory; and iii) maneuverability. The method also includes determining a probability that the aircraft will traverse to the candidate position, and determining a presence of any collision hazards at the candidate position. A risk of collision is determined based on the determined probability that the aircraft will occupy the candidate position, and the determined presence of any collision hazards.

### CROSS-REFERENCE TO RELATED APPLICATION(S)

This application claims priority to European Application No. 24305482.2 filed on Mar. 28, 2024, entitled “Aircraft Collision Risk Determination,” the disclosure of which is incorporated herein by reference in its entirety.

### TECHNICAL FIELD

This disclosure relates to aircraft collision avoidance, in particular to a method of and an apparatus for determining an aircraft's risk of collision.

### BACKGROUND

Various systems exist for assisting aircraft to avoid collisions. However, these have several limitations.

Existing collision avoidance systems only consider the risk of a collision in a narrow window along the aircraft's planned flight path. This may reduce the amount of information available to a pilot or autopilot for making decisions. For instance, in situations where a significant deviation from the planned route is necessary, the pilot or autopilot may not have any information to help inform them of safe options.

Existing collision avoidance systems only consider the aircraft's ability to manoeuvre vertically; for example, the ability of the aircraft to fly over obstructions. Hence, existing systems ignore the aircraft's ability to move laterally, so as to manoeuvre around an object. Thus, existing systems may not provide useful information to a pilot or autopilot about all of the possible actions that they could take to avoid a collision.

Existing systems for avoiding collisions with the terrain do not account for dynamic hazards, such as aircraft or vehicles on the ground.

Existing collision avoidance systems provide a binary risk indicator. For instance, existing systems usually indicate that there is a risk of collision on a certain trajectory or there is not.

It is an aim of the present disclosure to provide an improved method of and an apparatus for determining an aircraft's risk of collision.

### SUMMARY

The present disclosure provides a method of determining an aircraft's risk of collision at a candidate position the method comprising: determining the candidate position to which the aircraft is capable of traversing within a time period, based on: i) an initial position of the aircraft; ii) an initial trajectory of the aircraft; and iii) a maneuverability of the aircraft; the method further comprising: determining a probability that the aircraft will traverse to the candidate position; determining a presence of any collision hazards at the candidate position; and determining the aircraft's risk of collision at the candidate position based on: i) the determined probability that the aircraft will occupy the candidate position; and ii) the determined presence of any collision hazards at the candidate position.

The time period may be different depending on the application for which the method is used. For instance, in some applications it may be preferable to only consider a candidate position if it is relatively proximate to the aircraft, e.g. within ten seconds, within thirty seconds, within a minute, etc., In other applications, a time period of, e.g., two or more minutes, five or more minutes, may be more appropriate.

The initial trajectory of the aircraft includes the direction of travel of the aircraft, and may include, e.g., the aircraft's current roll, angle of ascent or descent, or the like. The initial trajectory may include the aircraft's speed.

The maneuverability of the aircraft may be based on, for instance, any one or more (e.g. all) of: the aircraft's maximum roll; the aircraft's current speed; the aircraft's maximum speed; the aircraft's maximum acceleration; the aircraft's minimum speed; the aircraft's maximum deceleration; the aircraft's minimum turning radius; the maximum angle of ascent of the aircraft; the maximum descent of the aircraft.

In some examples, determining the probability that the aircraft will occupy the candidate position is based on the initial trajectory of the aircraft. For instance, the aircraft may be considered to be more likely to follow its initial trajectory than it is to deviate from its initial trajectory, e.g. with more significant deviations being increasing less likely.

In some examples, the candidate position lies on a first candidate trajectory. This first candidate trajectory may be one of a plurality of candidate trajectories that the aircraft is capable of traversing.

In some examples, determining the probability that the aircraft will occupy the candidate position comprises: using a probability distribution to distribute a probability between a plurality of candidate trajectories, the plurality of candidate trajectories comprising the first candidate trajectory.

In some examples, determining the probability that the aircraft will occupy the candidate position comprises using a Gaussian probability distribution. Such a Gaussian distribution function may be used to distribute a probability between a plurality of candidate trajectories or between a plurality of candidate positions. Such a Gaussian distribution function may be tuned according to the application or based on various parameters (such as the aircraft's speed, the distance between the initial position and the candidate position or the like). For instance, tuning may be achieved by varying any of: the standard deviation, the expectation (which may coincide the initial trajectory of the aircraft or a planned trajectory of the aircraft), or the like.

In some examples, determining the presence of any collision hazards at the candidate position comprises: determining a probability of one or more collision hazards being present at the candidate position based on positional data for one or more collision hazards. The positional data may be, for instance, extracted from a database, received via the aircraft's sensors, received from an external system, or the like. The probability of the collision being present at the candidate position may be determined by distributing a probability of presence (e.g. using a Gaussian distribution) between positions horizontally and/or vertically offset from the received position (e.g. to account for any inaccuracies of the positional data).

In some examples, determining the aircraft's risk of collision at the candidate position is based on: iii) the probability of any collision hazard being present at the candidate position.

In some examples, determining the presence of any collision hazards at the candidate position comprises: determining whether any dynamic collision hazards are expected to traverse the candidate position based on positional data for one or more dynamic hazards and trajectory data for the one or more dynamic hazards.

The dynamic collision hazards may include any form of moving hazard, such as ground vehicles (e.g. on a runway), or aircraft (e.g. aeroplanes or the like). Dynamic collision hazards may include animals, such as birds or land animals (e.g. on a runway).

The positional data and trajectory data may be, for instance, received via the aircraft's sensors, via an automatic dependent surveillance-broadcast (ADS-B) system (e.g. in the case of the dynamic hazard being another aircraft), received from an external system (e.g. an external system monitoring a runway), or the like.

In some examples, the method comprises determining an expected time of presence at the candidate position for any dynamic collision hazards based on the positional data for the one or more dynamic collision hazards and the trajectory data for the one or more dynamic collision hazards. This may include, for example, assuming a constant velocity of the dynamic collision hazard (e.g. if no other information about the dynamic collision hazard's expected trajectory is known).

In some examples, determining the aircraft's risk of collision at the candidate position is based on: iv) the expected time of presence of any dynamic collision hazards expected to occupy the candidate position. For instance, there may be little or no risk of collision if the expected time of presence of a dynamic hazard at the candidate position is outside of the time period being considered.

In some examples, the method comprises determining an expected time of presence of the aircraft at the candidate position based on: i) the initial position of the aircraft; ii) the initial trajectory of the aircraft; and iii) the initial speed of the aircraft. The expected time of presence may be a time window. For instance, a start of the time window may be determined by assuming a minimum speed of the aircraft or a maximum deceleration of the aircraft. An end of the time window may be determined by assuming a maximum speed of the aircraft or a maximum acceleration. The expected time of presence may be determined by assuming a constant speed of the aircraft.

In some examples, determining the aircraft's risk of collision at the candidate position is based on: iv) the expected time of presence of the aircraft at the candidate position. For instance, if the expected time of presence of the aircraft at the candidate position coincides with an expected time of presence of a dynamic collision hazard, there may be a high risk of collision at the candidate position. However, there may be a low, or zero, risk of collision at the candidate position if the aircraft's expected time of presence at the candidate position does not coincide with a dynamic collision hazard's expected time of presence at the candidate position (e.g. if the dynamic collision hazard is expected to occupy the candidate position at a significantly earlier or later time than the aircraft).

In some examples, determining the probability that the aircraft will occupy the candidate position is based on a distance between the aircraft's initial position and the candidate position. For instance, as the aircraft moves further from its initial position, it may be considered more likely to deviate (e.g. more significantly) from its initial trajectory or a planned trajectory.

In some examples, determining the probability that the aircraft will occupy the candidate position is based on an initial speed of the aircraft. For instance, if the initial speed of the aircraft is relatively fast, the aircraft may be considered less likely to make a significant deviation from its initial trajectory within a certain distance (due to the limited time in which to make a significant deviation). If the initial speed of the aircraft is relatively slow, the aircraft may be considered more likely to make a significant deviation from its initial trajectory within the same distance (e.g. as there is more time available to make a more significant deviation to the aircraft's trajectory).

In some examples, the method comprises providing a risk indicator based on the aircraft's determined risk of collision at the candidate position. This risk indicator may be provided to a pilot, an autopilot, or the like. Such a risk indicator may be continuous (e.g. a numerical probability of risk) or categorised (e.g. using certain risk thresholds). Categories of risk could include, for example, any of: no risk, low risk, moderate risk, high risk or the like.

In some examples, the method is repeated at a plurality of time intervals. For instance, to continuously monitor risk as the aircraft (and optionally also dynamic hazards) move.

In some examples, the method is repeated for each of a plurality of candidate positions to which the aircraft is capable of traversing within the time period, so as to determine a risk of collision at each of the plurality of candidate positions. Such a plurality of candidate positions may lie on different candidate trajectories (e.g. to assist in choosing which of a plurality of candidate trajectories to take). Such a plurality of candidate position may lie on the same candidate trajectory (e.g. to provide a risk associated with following a candidate trajectory that considers the risk of collision at a plurality of points along the trajectory).

In some examples, the method comprises determining the aircraft's risk of collision within a region based on the risk of collision for a plurality of candidate positions within the region. Such a region may include a plurality of candidate positions within a certain area or volume of space.

The present disclosure also provides a collision avoidance system for an aircraft, arranged to determine an aircraft's risk of collision at a candidate position by: determining a candidate position to which the aircraft is capable of traversing within a time period, based on: i) an initial position of the aircraft; ii) an initial trajectory of the aircraft; and iii) a maneuverability of the aircraft; determining a probability that the aircraft will traverse to the candidate position; determining a presence of any collision hazards at the candidate position; and determining the aircraft's risk of collision at the candidate position based on: i) the determined probability that the aircraft will occupy the candidate position; and ii) the determined presence of any collision hazards at the candidate position.

In use, any of the initial position, the initial trajectory and/or the maneuverability may be received from the aircraft. The collision avoidance system may comprise a memory. The memory may (be arranged to) have the maneuverability of the aircraft stored thereon. The collision avoidance system may be arranged to determine the maneuverability of the aircraft based on data (e.g. received from the aircraft or stored on the memory).

The determining of presence of any collision hazards may be determined based on positional data for one or more collision hazards. Such positional data may be received from an external system (such as an external database, the aircraft's sensors, via ADS-B or the like), which the collision avoidance system may be arranged to receive the positional data from. The collision avoidance system may comprise a database having the positional data stored thereon.

The previously described method may be carried out by such a collision avoidance system. Thus, it will be apparent that any of the (e.g. optional) features of the previously described method may apply equally to this collision avoidance system, as appropriate. In particular, the following features may apply.

In some examples, the collision avoidance system is arranged to determine the probability that the aircraft will occupy the candidate position based on the initial trajectory of the aircraft. The initial trajectory may be received from the aircraft, i.e. the collision avoidance system may be arranged to receive the initial trajectory, e.g. from the aircraft.

In some examples, the candidate position lies on a first candidate trajectory; and the collision avoidance system is arranged to determine the probability that the aircraft will occupy the candidate position using a probability distribution to distribute a probability between a plurality of candidate trajectories, the plurality of candidate trajectories comprising the first candidate trajectory. The collision avoidance system may be arranged to determine the plurality of candidate trajectories, e.g. based on the same criteria used for determining the candidate position.

In some examples, the collision avoidance system is arranged to determine the probability that the aircraft will occupy the candidate position comprises using a Gaussian probability distribution.

In some examples, the collision avoidance system is arranged to determine the presence of any collision hazards at the candidate position by: determining a probability of one or more collision hazards being present at the candidate position based on positional data for one or more collision hazards; and determine the aircraft's risk of collision at the candidate position based on: iii) the probability of any collision hazard being present at the candidate position.

In some examples, the collision avoidance system is arranged to determine the presence of any collision hazards at the candidate position by: determining whether any dynamic collision hazards are expected to traverse the candidate position based on positional data for one or more dynamic hazards and trajectory data for the one or more dynamic hazards.

The collision avoidance system may include an ADS-B module or the like arranged to receive the positional and/or trajectory data (e.g. from the dynamic hazard itself) for dynamic hazards (such as other aircraft). The collision avoidance system may be arranged to receive positional and/or trajectory data for dynamic hazards from the aircraft's sensors (e.g. RADAR, LIDAR or the like).

In some examples, the collision avoidance system is arranged to determine an expected time of presence at the candidate position for any dynamic collision hazards based on the positional data for the one or more dynamic collision hazards and the trajectory data for the one or more dynamic collision hazards.

In some examples, the collision avoidance system is arranged to determine the aircraft's risk of collision at the candidate position based on: iv) the expected time of presence of any dynamic collision hazards expected to occupy the candidate position.

In some examples, the collision avoidance system is arranged to determine an expected time of presence of the aircraft at the candidate position based on: i) the initial position of the aircraft; ii) the initial trajectory of the aircraft; and iii) the initial speed of the aircraft.

In some examples, the collision avoidance system is arranged to determine the aircraft's risk of collision at the candidate position is based on: v) the expected time of presence of the aircraft at the candidate position.

In some examples, the collision avoidance system is arranged to determine the probability that the aircraft will occupy the candidate position based on a distance between the aircraft's initial position and the candidate position.

In some examples, the collision avoidance system is arranged to determine the probability that the aircraft will occupy the candidate position based on an initial speed of the aircraft.

In some examples, the collision avoidance system is arranged to provide a risk indicator based on the aircraft's determined risk of collision at the candidate position. This may be provided to the aircraft's autopilot, a pilot of the aircraft (e.g. via a display screen in the aircraft's cockpit) or the like.

In some examples, the collision avoidance system is arranged to repeat the previously mentioned steps at a plurality of time intervals.

In some examples, the collision avoidance system is arranged to repeat the previously mentioned steps for each of a plurality of candidate positions to which the aircraft is capable of traversing within the time period, so as to determine a risk of collision at each of the plurality of candidate positions.

In some examples, the collision avoidance system is arranged to determine the aircraft's risk of collision within a region based on the risk of collision for a plurality of candidate positions within the region.

### BRIEF DESCRIPTION OF DRAWINGS

One or more non-limiting examples will now be described, by way of example only, and with reference to the accompanying figures in which:

FIG. 1 shows a top down view of an aircraft in flight and various trajectories the aircraft could follow;

FIG. 2 shows another top down view of the aircraft in flight;

FIG. 3 shows plots of probability distributions curves shown in FIG. 2;

FIG. 4 shows a side view of the aircraft in flight;

FIG. 5 shows plots of probability distributions curves shown in FIG. 4;

FIG. 6 shows an object's position, based on data received by the aircraft's terrain awareness and warning system;

FIG. 7 shows a position of terrain, based on data received by the aircraft's terrain awareness and warning system;

FIG. 8 shows a method of determining a risk of the aircraft colliding with an object or the terrain;

FIG. 9 shows a particular example of the method shown in FIG. 8;

FIG. 10 shows the risk associated with various positions within the flyable space around the aircraft, determined using the method of FIG. 8;

FIG. 11 shows a risk indicator that indicates the risk of a collision in various directions;

FIG. 12 shows a top-down view of the aircraft in flight and a second aircraft in flight, as well as the risk of the first and second aircrafts colliding at various positions; and

FIG. 13 shows a system for performing the methods of FIGS. 8 and 9.

### DETAILED DESCRIPTION

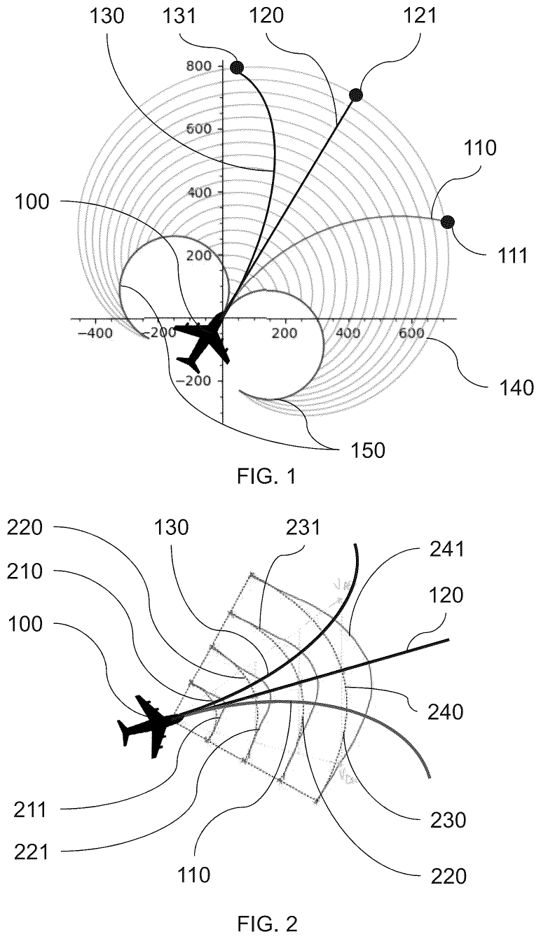

FIG. 1 shows a top down view of an aircraft 100 in flight. The aircraft 100 has a planned flight path 110, i.e. a flight plan. If the aircraft 100 continues on its planned flight path 110, the aircraft will occupy a first position 111 in the horizontal plane after travelling a certain distance along this planned flight path 110.

FIG. 1 also shows a second flight path 120, which follows the aircraft's current trajectory, i.e. the second light path 120 is an extrapolation of the aircraft's 100 current trajectory. In this example, the aircraft's 100 current trajectory is substantially straight, however in other examples the aircraft 100 may be following a curved trajectory (e.g. based on the current roll of the aircraft). If the aircraft 100 follows the second flight path 120, it will occupy a second position 121 in the horizontal plane after travelling a certain distance along this second flight path 120.

Additionally, FIG. 1 shows a third flight path 130. If the aircraft follows the third flight path 130, it will occupy a third position 131 in the horizontal plane after travelling a certain distance along the third flight path 130.

An arc 140 links positions that correspond to the aircraft 100 travelling the same distance, in the horizontal plane, along different trajectories. Other arcs, which correspond to different distances in the horizontal plane along possible trajectories of the aircraft 100, are also shown in the Figure, but not labelled.

The arc 140 corresponds to the furthest distance in the horizontal plane that the aircraft 100 may travel within a certain time period. This distance may be determined by assuming a constant speed of the aircraft 100, a maximum acceleration of the aircraft 100, a maximum speed of the aircraft or the like. In this example, a constant speed is assumed.

A minimum turning radius 150 of the aircraft 100 is shown on the Figure. This minimum turning radius 150 takes into account the aircraft's 100 maneuverability, for instance the aircraft's 100 maximum roll in the case of an aeroplane. Additionally, the minimum turning radius 150 takes into account the wind direction and speed. The minimum turning radius defines the end points of the arc 140, and also the other arcs shown in FIG. 1.

In this example, the minimum turning radius 150 is determined by assuming that the aircraft's 100 speed is constant. However, if the aircraft's 100 speed is reduced, the aircraft 100 may be able to perform a turn with a smaller radius. Thus, in other examples, the minimum turning radius 150 may instead be defined by assuming a minimum speed and/or a maximum deceleration of the aircraft. Such an approach may allow for deceleration of the aircraft 100, however it may be computationally harder to implement.

FIG. 2 shows another top down view of the aircraft 100 in flight. FIG. 2 shows several arcs 210, 220, 230, 240. These arcs 210, 220, 230, 240 link positions that corresponding to the aircraft 100 travelling the same distance, in the horizontal plane, along different trajectories.

A first arc 210 links positions that correspond to the aircraft 100 travelling a first distance, in the horizontal plane, along different trajectories. The probability of the aircraft intersecting the first arc 210 at each position along the first arc 210 is shown using a first probability curve 211.

Given that this first arc 210 is relatively close to aircraft 100, the aircraft 100 has relatively little time to turn before reaching it. Thus, the probability that the aircraft 100 will intersect the first arc 210 at a position near the centre of the arc 210, following the aircraft's 100 current trajectory 120, is relatively high. Contrastingly, the aircraft 100 is less likely to intersect the first arc 210 at positions that would require significant deviations to the aircraft's 100 current trajectory 120.

A second arc 220 and a third 230 arc in the horizontal plane are successively further from the starting position of the aircraft 100. The second arc 220 has a corresponding second probability curve 221, and the third arc 230 has a third probability curve 231.

A fourth arc 240 in the horizontal plane is the furthest arc from the aircraft's 100 starting position. The fourth arc 240 links positions that correspond to the aircraft 100 travelling a fourth distance, in the horizontal plane, along different trajectories. A fourth probability curve 241 shows the probability of the aircraft's 100 horizontal position intersecting each position along this arc 240.

As the fourth arc 240 is located further from the aircraft's 100 starting position than the first arc 210, the aircraft 100 has more time to turn before the aircraft's horizontal position intersects the fourth arc 240. As a result, a greater deviation from the aircraft's 100 current trajectory 120 is more likely when the aircraft's horizontal position intersects the fourth arc 240. Hence, as can be seen in FIG. 2, the fourth probability curve 241 has a more evenly distributed probability distribution than the first probability distribution curve 211.

This more even probability distribution corresponds to the divergence of the planned flight path 110, the aircraft's current trajectory 120, and the third flight path 130 as the distance travelled from the aircraft's 100 initial position increases.

In this example, the probability distribution curves 211, 221, 231, 241 are based on Gaussian probability distribution curves. In other words, the shapes of the probability curves 211, 221, 231, 241 shown in FIG. 2 are defined using Gaussian probability functions.

Gaussian probability functions are not normally bounded. However, in this case, the probability distribution curves 211, 221, 231, 241 are limited to a region of interest. This region of interest includes all positions along the respective arc 210, 220 230, 240 that are within a +/−three sigma deviation (i.e. within three standard deviations either side) of the position of highest probability (assuming that this is within the volume of space that the aircraft is capable of occupying within a certain distance or time). Once bounded, the probabilities are scaled up, such that the aircraft 100 is modelled as having a unity probability of occupying a position on the arc 210, 220, 230, 240 within the region of interest.

While in this example, Gaussian probability distribution functions are used, in other examples any suitable probability distribution function could be used to define the shape of each the probability curves 211, 221, 231, 241. For instance, it may be preferable to use a linear probability distribution, for ease of computation of the probabilities. Alternatively, for instance, a Gaussian probability function might be applied to the aircraft's roll, which may result in a non-gaussian probability distribution along each arc as the relationship between the angle of the aircraft's 100 roll and the position on each arc 210, 220, 230, 240 is non-linear.

In this example, the probability distribution curves 211, 221, 231, 241 are generated by assuming that the aircraft 100 is considered more likely to continue on its current trajectory 120 than it is to turn. Thus, the position with a highest probability along each arc 210, 220, 230, 240 is the position where the current trajectory 120 intersects the corresponding arc 210, 220, 230, 240. As will become clear from this description, this may be useful to inform a pilot or autopilot of the need to deviate from the aircraft's 100 current trajectory 120 to avoid a collision.

However, in other examples, the probability distribution curves 211, 221, 231, 241 may be generated by assuming that the aircraft 100 is most likely to follow the aircraft's 100 planned flight path 110. Thus, the position with a highest probability along each arc 210, 220, 230, 240 may instead be the position where the planned flight path 110 intersects each of the arcs 210, 220, 230, 240. Thus, in other examples, the probability curves 211, 221, 231, 241 may have a skewed shape, rather than a symmetric shape. This may be useful to inform a pilot or autopilot of the need to deviate from the aircraft's 100 planned flight path 110 to avoid a collision.

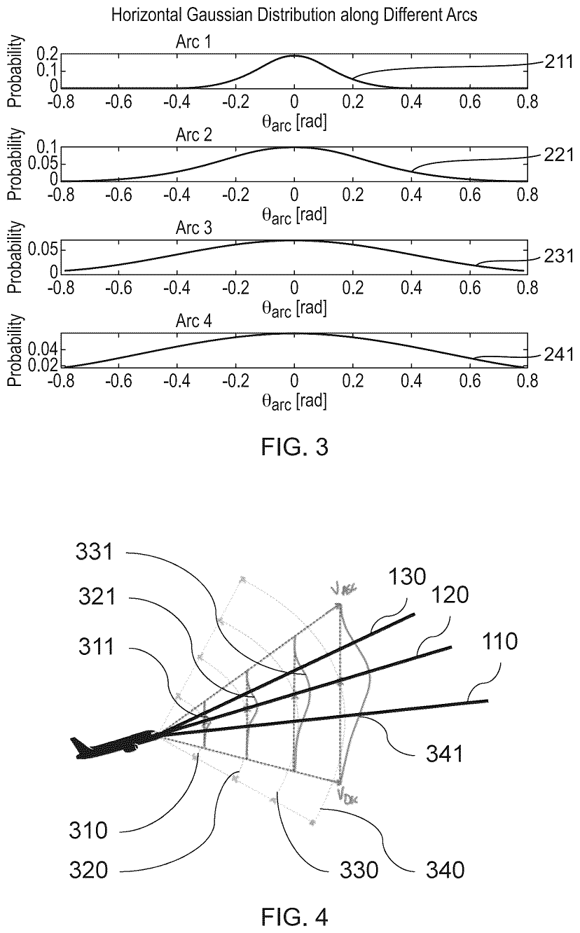

FIG. 3 shows plots of the probability distributions curves 211, 221, 231, 241 shown in FIG. 2. As previously mentioned, the probability that the horizontal position of the aircraft will deviate from the horizontal position corresponding to the aircraft's 100 current trajectory 120 increases further from the aircraft's 100 starting position, as this allows more time for the aircraft 100 to manoeuvre.

FIG. 4 shows a side view of the aircraft 100 in flight. FIG. 4 shows a first arc 310 in a vertical plane. The first arc 310 links positions that correspond to the aircraft 100 travelling a first distance, in the vertical plane, along different trajectories. The first arc 310 is determined by considering the maximum climb capability of the aircraft 100 and the maximum descent capability of the aircraft 100, e.g. during normal flight. This takes into account the aircraft's 100 maneuverability, i.e. the maximum amount that the aircraft is able to ascend or descend, e.g. assuming constant speed, a constant component of speed in the vertical plane, a maximum deceleration, a minimum speed or the like. Wind speed and/or direction may also be taken into account. In this example, constant speed is assumed.

The probability of the aircraft's 100 position intersecting each position along the first arc 310 is shown using a first probability curve 311. Given that this first arc 310 is relatively close to aircraft 100, the probability that the aircraft's position in the vertical plane 100 will intersect the first arc 310 near the centre, following the aircraft's 100 current trajectory 120, is relatively high. Contrastingly, the vertical position of the aircraft 100 is less likely to intersect the first arc 310 at positions that would require significant deviations to the aircraft's 100 current trajectory 120.

A second arc 320 and a third 330 arc in the vertical plane are successively further from the starting position of the aircraft 100. The second arc 320 has a corresponding second probability curve 321 and the third arc 330 has a third probability curve 331.

A fourth arc 340 in the vertical plane is the furthest arc away from the aircraft 100. The fourth arc 340 links positions that correspond to the aircraft 100 travelling a fourth distance, in the vertical plane, along different trajectories. A fourth probability curve 341 shows the probability of the aircraft 100 occupying any position along this arc 340.

As the fourth distance is greater than the first distance, the aircraft 100 has more time to ascend or descend before reaching the fourth arc 340 than the first arc 310. As a result, a greater deviation from the aircraft's 100 current trajectory 120 is more likely by the time the aircraft's 100 vertical position intersects the fourth arc 340. Hence, as can be seen in FIG. 4, the fourth probability curve 341 has a more even probability distribution than the first probability distribution curve 311.

In this example, the probability distribution curves 311, 321, 331, 341 are based on Gaussian probability distribution curves, i.e. their shapes are defined by Gaussian probability functions. However, as per the probability curves 211, 221, 231, 241 shown in FIG. 2, other suitable probability distribution functions could instead be used. The ends of the arcs 310, 320, 330, 340 correspond to a +/−three sigma deviation from the most probable intersection point (assuming that this is within the volume of space that the aircraft 100 is capable of occupying within a certain distance or time), using a similar approach to the approach outlined in the description of FIG. 2.

In this example, the aircraft 100 is considered more likely to continue on its current trajectory 120 than it is to adjust its angle of ascent or descent. Thus, the position with a highest probability along each arc 310, 320, 330, 340 is the position where the current trajectory 120 intersects the corresponding arc 310, 320, 330, 340. However, in other examples the aircraft 100 may be modelled as most likely to follow the aircraft's 100 planned flight path 110.

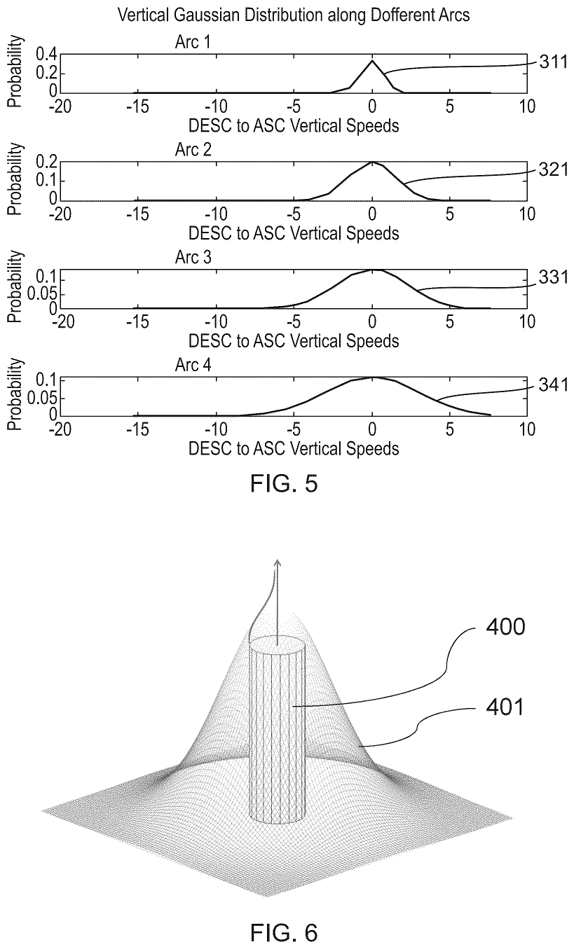

FIG. 5 shows plots of the probability distributions curves 311, 321, 331, 341 shown in FIG. 4. As previously mentioned, the probability of the position of the aircraft 100 in the vertical plane deviating significantly from the aircraft's 100 current trajectory 120 increases further from the aircraft's 100 starting position, as this allows more time for the aircraft 100 to manoeuvre.

It is possible to determine a probability of the aircraft occupying a position in three-dimensional space by combining the probability that the aircraft 100 will occupy a corresponding position in each of the horizontal plane and the vertical plane.

However, while the approach described above considers the horizontal plane and vertical plane independently, it is also possible to define a three-dimensional surface of positions that the aircraft 100 could occupy after travelling a certain distance from the aircraft's 100 starting position. A three-dimensional probability distribution function may then be used to determine the probability of the aircraft 100 occupying any of the positions on the three-dimensional surface. By way of example, a three-dimensional Gaussian distribution function may be used to distribute a probability of occupancy across the surface. The position on the surface corresponding to the maximum probability of occupancy may be the intersection of the aircraft's 100 current trajectory 120 and the three-dimensional surface.

FIG. 6 shows an object's position 400. The object may be a building, a tree, a pylon for power transmission or the like. The object's position 400 is based on positional data received by the aircraft's 100 terrain awareness and warning system (TAWS). FIG. 6 also shows a volume 401 around the object's position 400. This volume 401 includes possible positions that the object might actually occupy, accounting for the fact that the data received by the TAWS may not be accurate.

Information about the object's position 400 may come from sensors, for instance sensors on the aircraft 100, such as LiDAR sensors, radar sensors or the like. Additionally, or alternatively, information about the object's position 400 may come from a database, which includes data about the surrounding terrain and the position of various objects.

In any case, there is a risk that the data received by the TAWS may not be accurate. In examples where the object's position 400 is provided as an input based on sensor data, this inaccuracy may arise from sensor errors and uncertainties. In examples where the object's position 400 is provided as an input from a database, this inaccuracy may arise from uncertainties and errors in the information included in the database.

Thus, a probability of the object occupying any position is modelled using a probability distribution function (e.g. a Gaussian probability distribution function). The volume 401 corresponds to positions within a (e.g. +/−three sigma) variance of the received position 400 of the object. The Gaussian distribution function may be tuned, for instance, according to an expected accuracy of the received data or the specific application.

When using the probability distribution function, the position modelled as the most likely position of the object is the position 400 corresponding to the received data. Therefore, the volume 401 around the object's received position 400 extends horizontally and vertically away from the received position 400. The further from the received position 400, the less likely that the object will be present. In contrast, the object is very likely to be positioned within, or proximate to, the received location 400.

By using an appropriate probability distribution, for instance a Gaussian probability distribution, it is possible to model the probability of presence of an object at any position within the volume 401.

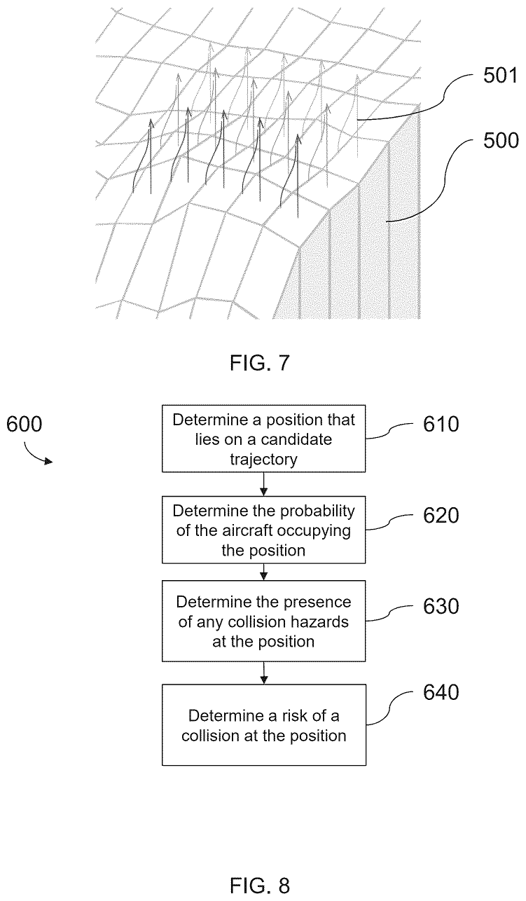

FIG. 7 shows a position 500 of terrain in an area proximate to the aircraft 100. The position 500 of the terrain is based on data received by the aircraft's 100 TAWS. FIG. 7 also shows that the terrain may be positioned at a vertical or horizontal offset from the received position of the terrain. This is shown by the error indicators 501 in the Figure.

The terrain is usually modelled as a grid of elevations. Each cell of the grid represents a volume of terrain. Typically, the elevation of the terrain in a certain grid cell is the maximum terrain elevation within the cell. However, the position and the elevation of the terrain is only known to a certain accuracy. Hence, each terrain source has an expected horizontal and/or vertical accuracy, either globally or locally, e.g. as +/−x meters within, e.g., y % accuracy. This may be used in the determination of the error indicators 501.

The probability of terrain presence can be determined using the stated elevation of the cell containing the terrain, and the accuracy of this elevation. This may be expressed as a probability distribution. For safety, the terrain is assumed to have a minimum elevation corresponding to the received elevation. If the accuracy of each grid cell is not known, an arbitrary probability distribution may be used (e.g. based on a safety margin deemed appropriate).

FIG. 8 shows a method 600 of determining the risk of the aircraft 100 colliding with an object, such as the object shown in FIG. 6, or the surrounding terrain, such as the terrain shown in FIG. 7.

A first step 610 of the method 600 includes determining a position, that lies on a candidate trajectory that the aircraft 100 could follow. This may include determining the flyable space defined by all the trajectories that the aircraft is capable of following. The candidate trajectory is determined based on the aircraft's 100 current position, the aircraft's 100 current trajectory 120 and information about the aircraft's 100 maneuverability, such as its maximum roll in the case of an aeroplane.

A second step 620 of the method 600 includes determining the probability of the aircraft 100 occupying the position on the candidate trajectory using the approach previously described with reference to FIGS. 2 to 5.

A third step 630 of the method 600 includes determining whether any collision hazards are present at each of the candidate positions. A collision hazard could be an object, the terrain or a dynamic hazard such as another aircraft. Additionally, the presence of a collision hazard may have an associated probability. The probability of an object or the terrain being present can be determined using the approach described with reference to FIGS. 7 and 8.

Finally, a fourth step 640 of the method 600 includes determining a risk of a collision at the position based on the combination of the probability of the aircraft occupying the position and the presence of any collision hazards.

The method 600 is repeated for positions throughout a volume of space that the aircraft 100 is able to occupy within a certain time period. This volume may be determined in the manner previously described in the description of FIGS. 1 to 5. The positions may be evenly or unevenly distributed across the flyable space around the aircraft 100.

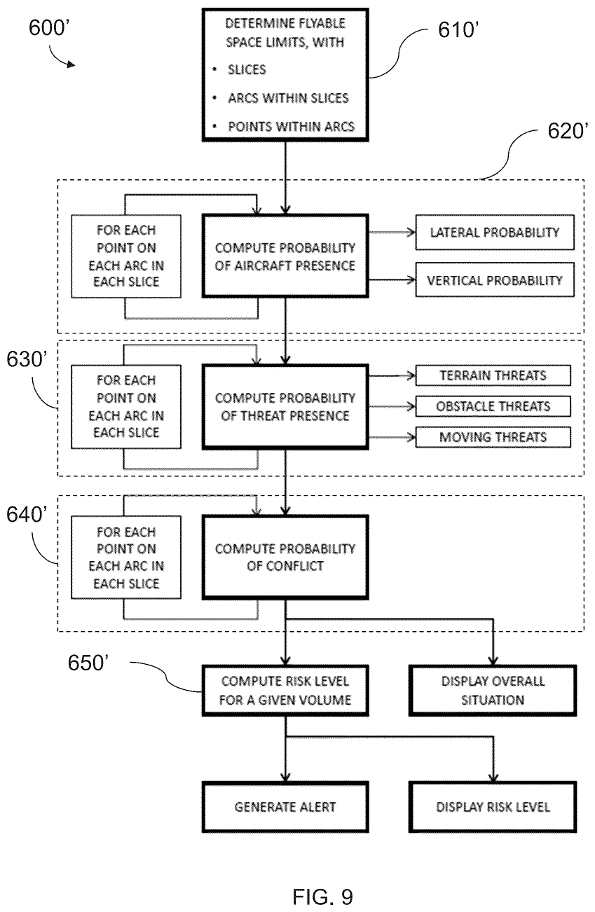

FIG. 9 shows a particular example 600′ of the method 600 shown in FIG. 8.

The first step 600′ determining a plurality of positions that the aircraft 100 is capable of occupying (e.g. within a certain distance or time).

The second step 620′ includes determining the probability of the aircraft 100 being present at each position, using the previously described approach.

The third step 630′ includes determining the probability of any collision hazards (i.e. threats) being present at each position. This may include the terrain (i.e. terrain threats), objects (i.e. obstacle threats) or dynamic hazards (i.e. moving threats). This may be displayed, e.g. graphically or numerically.

The method 600′ includes a fourth step of determining a probability of conflict (i.e. collision) based on the outputs of the second step 620′ and the third step 630′.

This method 600′ also includes a fifth step 650′ of determining a risk associated with a volume of the aircraft's 100 flyable space. This is determined based on the risk of collision associated with a plurality of points within the volume. The risk associated with a volume may be displayed, e.g. graphically or numerically. An alert may be generated if the risk is above a certain threshold.

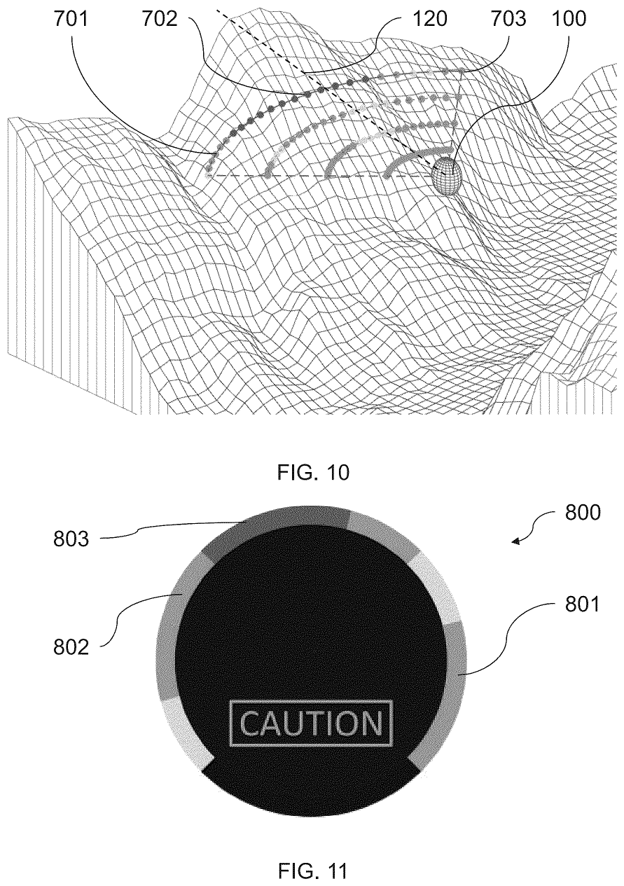

FIG. 10 shows the risk of a collision for various positions within the flyable space around the aircraft 100, determined using the method of FIG. 8.

A first position 701 is shown in FIG. 10. At the first position 701, there is a high risk of the terrain being present. However, the aircraft 100 is relatively unlikely to occupy this position 701 as it would require a significant deviation from the aircraft's flight path. Thus, the method 600 determines a moderate level of risk associated with this first position 701. If the aircraft 100 approaches this first position 701, the level of associated risk of collision would increase as a result of the increased probability of presence of the aircraft 100.

At a second position 702, shown in FIG. 9, the probability that terrain is present is very high. The probability of presence of the aircraft 100 is also high, as this position 702 is proximate to the aircraft's 100 current trajectory 120. Thus, the method 600 determines a high level of risk associated with this position 702.

At a third position 703, shown in FIG. 9, the probability of presence of the aircraft 100 is relatively low, as this would require a reasonably significant deviation to the aircraft's 100 current trajectory 120. Additionally, there is no terrain present at this position 703, i.e. no probability of terrain, and therefore there is no risk of a collision. Thus, the method 600 determines that there is no risk associated with this position 703.

In FIG. 10, only positions in a plane corresponding to the aircraft's 100 current angle of elevation are shown. However, positions are also considered that correspond to different elevation angles, to ensure that the entirety of the flyable space around the aircraft 100 is accounted for.

FIG. 11 shows a risk indicator 800 that indicates, for example to a pilot or an autopilot, the risk of a collision in various directions either side of the aircraft's 100 current trajectory 120. This may be generated using the method 600′ shown in FIG. 9, e.g. by determining the risk associated with a plurality volumes within the aircraft's 100 flyable space. Such volumes may include positions above and/or below the aircraft's 100 current angle of elevation.

A region of low risk 801 is shown in the Figure. This corresponds to a low probability of terrain or objects in this region, and a low probability of occupancy by the aircraft 100.

A region of moderate risk 802 is shown in the Figure. This corresponds to a moderate probability of presence of terrain or objects in this region, and a moderate probability of occupancy by the aircraft 100.

An area of high risk 803 is also shown in the Figure. This corresponds to a high probability of presence of terrain or objects in this region and a high probability of occupancy by the aircraft 100. Based on the aircraft's current trajectory 120, the aircraft 100 will enter this region 803 unless it performs a manoeuvre.

Using the risk indicator shown in FIG. 11, a pilot or autopilot may choose to turn towards the area of low risk 801 so as to avoid a risk of collision.

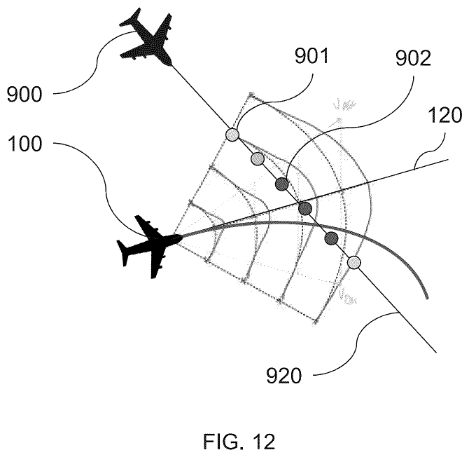

FIG. 12 shows a top-down view of the aircraft 100 in flight and a second aircraft 900 in flight. The trajectory 120 of the first aircraft 100 is shown, as is the trajectory 920 of the second aircraft 900.

The first aircraft 100 has a traffic collision avoidance system (TCAS), which receives the position and trajectory 920 of the second aircraft 900, and at any given point in time the position of the second aircraft 900 is estimated based on the most recently received position (e.g. including its altitude) and trajectory 920 (i.e. bearing). The position and trajectory 920 of the second aircraft 900 may be determined using sensors on the first aircraft 100. Alternatively, for example, this information may be broadcast by the second aircraft 900 using an automatic dependent surveillance-broadcast (ADS-B) system, as is commonplace in the aerospace industry.

An expected position of the second aircraft 900 may be determined at various points in time based on the second aircraft's 900 current position, speed and trajectory. Hence, it is possible for the TCAS to account for the expected position of the second aircraft 900 to assess a risk of collision with the second aircraft 900.

In FIG. 11, a first position 901 is shown where there is a moderate risk of collision. The risk arises as there is a relatively low probability of the first aircraft being present in this position 901, however if the first aircraft 100 is present in this position it would collide with the second aircraft 900 (unless the second aircraft's 900 trajectory 920 changes or the first aircraft's 100 speed changes).

A second position 902 has a high risk of collision. This is as a result of a high probability of presence of the first aircraft 100 at a certain time (assuming constant speed of the first aircraft 100), in combination with the fact that the second aircraft 900 will also be present at this position 902 at the same time (unless the trajectory 920 of the second aircraft 900 changes).

While FIG. 12 only illustrates the use of this approach in two dimensions, it is clearly possible to use the same approach in three dimensions. Thus, it is possible to account for the presence of dynamic hazards, such as the second aircraft 900, in the third step 630 of the method 600 of FIG. 8.

It is possible to model uncertainty of the position of any of the dynamic risks, e.g. the second aircraft 900, using the same approach as is described previously for objects in the description of FIG. 6.

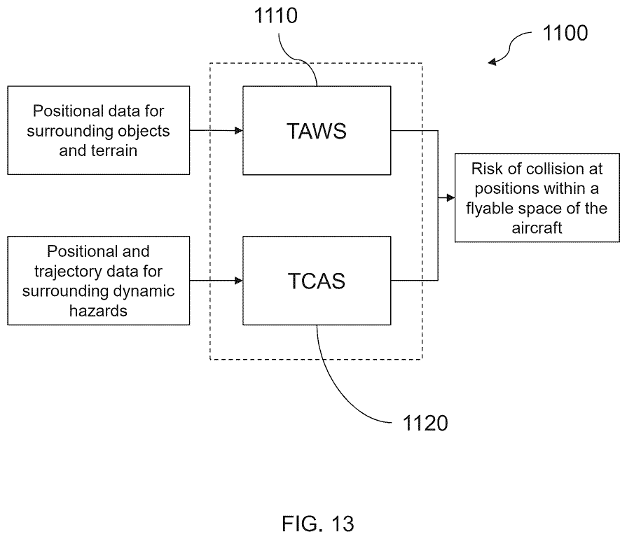

FIG. 13 shows a system 1100 arranged to perform the method 600 shown in FIG. 8 (and/or the method 600′ of FIG. 9). The system 1100 is a computer implemented system.

The system 1100 includes a TAWS module 1110 and a TCAS module 1120. The TAWS module 1110 is arranged to receive positional data relating to surrounding terrain and objects. The TCAS module 1120 is arranged to receive positional and trajectory data relating to dynamic hazards, such as moving objects and vehicles (such as other aircrafts). Positional and trajectory data may be received from sensors on the aircraft, a database, via ADS-B or the like.

In this example, the TAWS 1110 module is arranged to perform the third step 630 of the method 600 of FIG. 8 for stationary hazards, and the TCAS module 1120 is arranged to perform the third step 630 of the method 600 of FIG. 8 for dynamic hazards.

As previously mentioned, the location of static hazards (such as objects or the terrain) may be received from databases, or by sensors, such as radar, lidar or the like. Thus, the system 1100 may include sensors for capturing hazard data.

The location of dynamic hazards may be received from surveillance systems, such as TCAS, an airborne collision avoidance systems (ACAS), ADS-B, data-link or the like. The system 1100 may include any of these sub-systems.

By considering all of the flyable area around the aircraft when assessing risk, the methods of assessing the risk described above may provide more information to inform a pilot or autopilot than existing methods.

Consideration of moving objects, such as other aircrafts, may enable the methods of risk assessment described above to better help avoid collisions with moving objects than existing methods.

As the methods described above take an approach that determines a probability of collision, it is possible to have an indicator of risk that is not merely binary in nature. Thus, pilots or autopilots may receive information about the risks as they develop and get progressively better or worse. This indicator of risk may be updated by performing the method 600 of FIG. 8 in real-time, e.g. at regular time intervals or continuously.

By using a probabilistic method to assess risk, it is possible to adjust any of the probability distributions used in order to tune the above methods to different applications and flight scenarios where risks of collisions may be more or less likely.

It will be appreciated by those skilled in the art that this disclosure has been illustrated by describing one or more specific examples thereof, but is not limited to these examples; many variations and modifications are possible, within the scope of the accompanying claims.

What is claimed is:

1. A method of determining an aircraft's risk of collision at a candidate position, the method comprising:
determining the candidate position to which the aircraft is capable of traversing within a time period, based on:
an initial position of the aircraft;
an initial trajectory of the aircraft; and
a maneuverability of the aircraft;
the method further comprising:
determining a probability that the aircraft will occupy the candidate position;
determining a presence of any collision hazards at the candidate position; and
determining the aircraft's risk of collision at the candidate position based on:
the determined probability that the aircraft will occupy the candidate position; and
the determined presence of any collision hazards at the candidate position.

2. The method as claimed in claim 1, wherein determining the probability that the aircraft will occupy the candidate position is based on the initial trajectory of the aircraft.

3. The method as claimed in claim 1, wherein the candidate position lies on a first candidate trajectory; and
wherein determining the probability that the aircraft will occupy the candidate position comprises:
using a probability distribution to distribute a probability between a plurality of candidate trajectories, the plurality of candidate trajectories comprising the first candidate trajectory.

4. The method as claimed in claim 1, wherein determining the probability that the aircraft will occupy the candidate position comprises using a Gaussian probability distribution.

5. The method as claimed in claim 1, wherein determining the presence of any collision hazards at the candidate position comprises:
determining a probability of one or more collision hazards being present at the candidate position based on positional data for one or more collision hazards; and
wherein determining the aircraft's risk of collision at the candidate position is further based on:
the probability of any collision hazard being present at the candidate position.

6. The method as claimed in claim 1, wherein determining the presence of any collision hazards at the candidate position comprises:
determining whether any dynamic collision hazards are expected to traverse the candidate position based on positional data for one or more dynamic hazards and trajectory data for the one or more dynamic hazards.

7. The method as claimed in claim 6, wherein the method comprises determining an expected time of presence at the candidate position for any dynamic collision hazards based on the positional data for the one or more dynamic collision hazards and the trajectory data for the one or more dynamic collision hazards; and
wherein determining the aircraft's risk of collision at the candidate position is further based on:
the expected time of presence of any dynamic collision hazards expected to occupy the candidate position.

8. The method as claimed in claim 1, wherein the method comprises determining an expected time of presence of the aircraft at the candidate position based on:
the initial position of the aircraft;
the initial trajectory of the aircraft; and
the initial speed of the aircraft; and
wherein determining the aircraft's risk of collision at the candidate position is further based on:
the expected time of presence of the aircraft at the candidate position.

9. The method as claimed in claim 1, wherein determining the probability that the aircraft will occupy the candidate position is based on a distance between the aircraft's initial position and the candidate position.

10. The method as claimed in claim 1, wherein determining the probability that the aircraft will occupy the candidate position is based on an initial speed of the aircraft.

11. The method as claimed in claim 1, wherein the method comprises providing a risk indicator based on the aircraft's determined risk of collision at the candidate position.

12. The method as claimed in claim 1, wherein the method is repeated at a plurality of time intervals.

13. The method as claimed in claim 1, wherein the method is repeated for each of a plurality of candidate positions to which the aircraft is capable of traversing within the time period, so as to determine a risk of collision at each of the plurality of candidate positions.

14. The method as claimed in claim 13, comprising determining the aircraft's risk of collision within a region based on the risk of collision for a plurality of candidate positions within the region.

15. The method as claimed in claim 3, wherein determining the presence of any collision hazards at the candidate position comprises:
determining a probability of one or more collision hazards being present at the candidate position based on positional data for one or more collision hazards; and
wherein determining the aircraft's risk of collision at the candidate position is further based on:
the probability of any collision hazard being present at the candidate position.

16. The method as claimed in claim 3, wherein determining the presence of any collision hazards at the candidate position comprises:
determining whether any dynamic collision hazards are expected to traverse the candidate position based on positional data for one or more dynamic hazards and trajectory data for the one or more dynamic hazards.

17. The method as claimed in claim 16, wherein the method comprises determining an expected time of presence at the candidate position for any dynamic collision hazards based on the positional data for the one or more dynamic collision hazards and the trajectory data for the one or more dynamic collision hazards; and
wherein determining the aircraft's risk of collision at the candidate position is further based on:
the expected time of presence of any dynamic collision hazards expected to occupy the candidate position.

18. The method as claimed in claim 3, wherein the method comprises determining an expected time of presence of the aircraft at the candidate position based on:
the initial position of the aircraft;
the initial trajectory of the aircraft; and
the initial speed of the aircraft; and
wherein determining the aircraft's risk of collision at the candidate position is further based on:
the expected time of presence of the aircraft at the candidate position.

19. The method as claimed in claim 2, wherein the candidate position lies on a first candidate trajectory; and
wherein determining the probability that the aircraft will occupy the candidate position comprises:
using a probability distribution to distribute a probability between a plurality of candidate trajectories, the plurality of candidate trajectories comprising the first candidate trajectory.

20. A collision avoidance system for an aircraft, configured and arranged to determine an aircraft's risk of collision at a candidate position by:
determining a candidate position to which the aircraft is capable of traversing within a time period, based on:
an initial position of the aircraft;
an initial trajectory of the aircraft; and
a maneuverability of the aircraft;
determining a probability that the aircraft will traverse to the candidate position;
determining a presence of any collision hazards at the candidate position; and
determining the aircraft's risk of collision at the candidate position based on:
the determined probability that the aircraft will occupy the candidate position; and
the determined presence of any collision hazards at the candidate position.
